(19) United States
(12) Patent Application Publication
(10) Pub. No.: US 2025/0023505 A1
(43) Pub. Date: Jan. 16, 2025

(54) A SYSTEM COMPRISING INSTALLED PANELS, A PANEL AND A METHOD FOR INSTALLING PANELS

(71) Applicant: BIPV.WORLD B.V., Waalwijk (NL)

(72) Inventor: Eugenio Julius Alphonsus Maria WIDLAK, Waalwijk (NL)

(21) Appl. No.: 18/713,526

(22) PCT Filed: Nov. 21, 2022
(86) PCT No.: PCT/EP2022/000106

§ 371 Date: May 24, 2024

(30) Foreign Application Priority Data
Nov. 26, 2021 (NL) 1044218

(51) Int. Cl. H02S 20/22; E04F 13/08

(52) U.S. Cl. CPC H02S 20/22; E04F 13/0832

(57) ABSTRACT

A system comprising rectangular panels being installed against the outer surface (7) of a building. Oblong support elements (6) provided with horizontal bars (8) are attached against said outer surface (7). The panels are attached to these horizontal bars (8). The panel may include a rectangular plate like element (1) at its frontside and two oblong holder members (2, 3) at its backside, wherein said holder members (2, 3) are positioned parallel with respect to each other and are located near opposite edges of the plate like element (1). Each holder member (2, 3) is provided with a first recess (4) and a second recess (5) and each recess (4, 5) engages one of said horizontal bars (8). At least a part of said first recess (4) extend in a direction parallel with respect to said plate like element (1) and said second recess (5) extend in a direction perpendicular with respect to said plate like element (1). The panels can be attached to the support elements (6) by moving the panel in such way that the first recesses (4) engage two bars (8) and subsequently the two second recesses (5) engage two other bars (8).

### CROSS-REFERENCE TO RELATED APPLICATIONS

This application is the U.S. national phase of International Application No. PCT/EP2022/000106 filed Nov. 21, 2022, which designated the U.S. and claims priority to NL 1044218 filed Nov. 26, 2021, the entire contents of each of which are hereby incorporated by reference.

The invention is related to a system comprising a rectangular panel being installed against the outer surface of a building, wherein oblong support elements are attached against said outer surface and wherein said support elements are provided with horizontal bars, wherein said panel comprises a rectangular plate like portion at its front site and comprises along two opposite edges of said plate like portion a backwards directed portion, wherein each backwards directed portion is provided with a first recess and a second recess, wherein each recess engages one of said horizontal bars and wherein at least a part of each first recess extend in a direction parallel with respect to said rectangular plate like portion and wherein each second recess extend in a direction perpendicular with respect to said rectangular plate like portion. Such system is described in publication WO 2016/102452 A1 and Publication EP 0 304 338 A1 describes first said first recesses having a part extending in a direction parallel with respect to said rectangular plate like portion.

A part of the outer surface of a building can be covered with panels in order to improve the appearance of that building or to provide the building with solar panels. For example, an old or damaged wall or roof can be covered by plates of high pressure laminate, being a material that can have any colour or combination of colours, and being a weather resistant material. The system according to the invention can be used for installing panels in an inclined plane or in a vertical plane, whereby the panel can be positioned in a flat plane or edges of the panels can be overlapping like tiles.

An object of the invention is a system comprising rectangular panels attached to oblong support elements, whereby an efficient connection between the panels and the support elements is achieved with a simple tool, when the panels are being installed against the support elements.

Another object of the invention is a system comprising rectangular panels attached to oblong support elements, whereby the panels can be installed in an efficient manner in a tiled mutual relation, whereby the panels are partly overlapping.

Another object of the invention is a system comprising rectangular panels attached to oblong support elements, whereby an installed panel can be easily removed from the support elements without removing surrounding panels.

In order to comply with one or more of these objects, the bars engaged by said second recess are provided with two locking members being rotatable around that bar between a locking position wherein the panel cannot move in the direction perpendicular with respect to the bar and an unlocked position wherein the panel can move away from the bar. Thereby the panel can be installed by moving the panel in such way that each of the first recesses of the two backwards directed portions of the panel engage a horizontal bar of a support element and that subsequently by moving the panel in such way that each of the two second recesses of the panel engages other bars of the support elements.

In a preferred embodiment said panel comprise a rectangular plate like element at the frontside of the panel and each backwards directed portion is an oblong holder member attached against the back side of said plate like element.

Preferably one of the two bars engaged by said second recess is provided with a fixation member being fixed to that bar, in such way that the concerning corner of the panel cannot move in a direction parallel with the bar.

Furthermore, the invention is related to a rectangular panel to be installed against oblong support elements being attached to the outer surface of a building, wherein said support elements are provided with horizontal bars, and wherein said panel comprises a rectangular plate like portion at its front site and comprises along two opposite edges of said plate like portion a backwards directed portion, wherein each backwards directed portion is provided with a first recess and a second recess, wherein each recess can engage one of said horizontal bars, wherein at least a part of each first recess extend in a direction parallel with respect to said rectangular plate like portion and wherein each second recess extend in a direction perpendicular with respect to said rectangular plate like portion, wherein the bars engaged by said second recess are provided with two locking members being rotatable around that bar between a locking position wherein the panel cannot move in the direction perpendicular with respect to the bar and an unlocked position wherein the panel can move away from the bar.

Preferably said plate like portion is a rectangular plate like element at the frontside of the panel and each backwards directed portion is an oblong holder member attached against the back side of said plate like element rectangular panel. Furthermore, the panel may be a solar panel provided with photovoltaic cells.

Furthermore, the invention is related to a method for installing a rectangular panel against the outer surface of a building, whereby oblong support elements being provided with bars in transverse direction are attached against said outer surface so that said bars are horizontal directed, whereby said panel comprises a rectangular plate like portion at its front site and comprises along two opposite edges of said plate like portion a backwards directed portion, whereby each backwards directed portion is provided with a first recess and a second recess, whereby each recess engages one of said horizontal bars, whereby at least a part of each first recess extend in a direction parallel with respect to said rectangular plate like portion and whereby each second recess extend in a direction perpendicular with respect to said rectangular plate like portion, whereby a locking member is rotated around one of the bars in such way that said bar cannot remove from said second recess.

The invention will now be further elucidated by means a description of an embodiment of the panel and its attachment to the support elements, whereby reference is made to the drawing comprising schematic and diagrammatical figures, whereby:

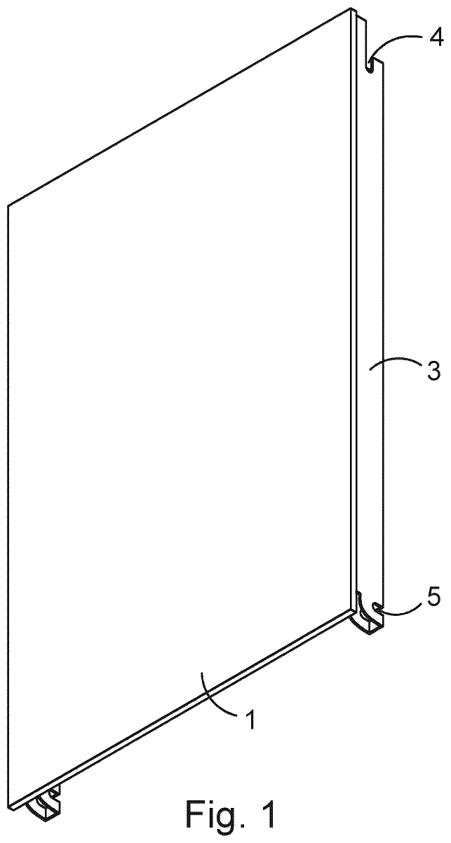

FIG. 1 is a perspective view of a panel;

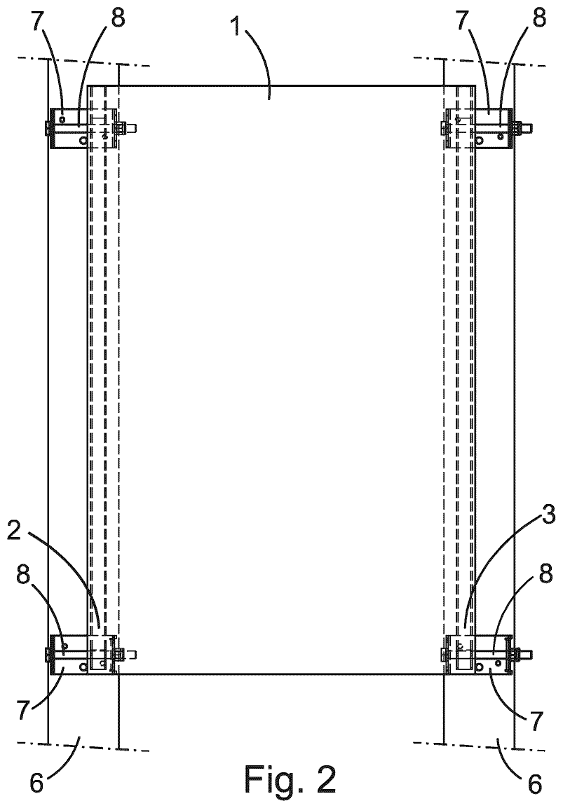

FIG. 2 is a front view of an installed panel;

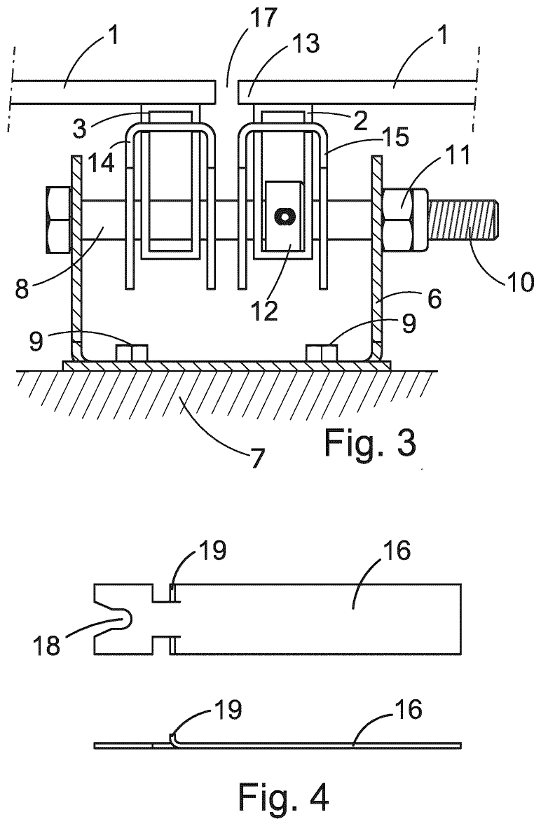

FIG. 3 shows the fastening of the panel;

FIG. 4 shows a special tool that can be used for fastening the panel, and

FIG. 1 shows a rectangular plate like element 1, wherein two holder members 2,3 are glued to the backside of the plate like element 1 near two opposite edges of the plate like element 1. Each holder member 2,3 is provided with a first recess 4 and a second recess 5. First recess 4 comprises a part extending in a direction parallel with respect to the plate like element 1. Second recess 5 extend in a direction perpendicular with respect to the plate like element 1.

FIG. 2 shows the panel 1,2,3 in front view and being installed against two oblong support elements 6. The support elements 6 can be attached against a vertical or an inclined part of a building or against any other object. The support elements 6 are provided with attachment elements 7, each comprising a horizontal bar 8 being engaged by recesses 4,5 in the holder members 2,3.

FIG. 3 shows the connection between the panel and a bar 8 of oblong support element 6. The support element 6 is attached to the outer wall 7 of a building by means of screws 9. Bar 8 is a bolt provided with thread 10 at its end. The bar 8 is fastened to the support element 6 by means of a self-locking nut 11. Before that, the bar 8 is provided with a fixation ring 12 being fixed two bar 8 and with two locking members 14,15 being rotatable around bar 8 between a locking position (being shown in FIG. 3) and an unlocked position. The fixation ring 12 has such dimension that the holder member 2 and therewith the corner 13 of the panel cannot move with regard to support element 6.

The installation of the panel against the support elements 6 is done as follows. At first, the panel is moved in such way that two bars 8 of different support elements 6 are located in the two first recesses 4 (see FIG. 1) of the holder members 2,3 at the backside of the panel. Thereinafter the panel is being rotated around said two bars 8, so that the two second recesses 5 (see FIG. 1) of the holder members 2,3 engage two other bars 8 of the support elements 6. After that the concerning locking members 14,15 are rotated from the unlocked position (see FIG. 6) into the locking position (see FIG. 7), which position is shown in FIG. 3. Thereby a special tool 16 is used.

FIG. 4 shows said special tool 16. Its dimension is such that the tool can pass through the space 17 between two neighbouring panels (see FIG. 3). The tool 16 has a recess 18 being able to engage bar 8. The tool 16 is provided with two bended parts 19 being able to engage the locking members 14,15 so that the locking member can be rotated around the bar 8 from the unlock position to the locking position and vice versa.

In the situation whereby the panel is rotating around the bars 8 (and being located in recesses 4 of that panel), so that each recess 5 of the panel approaches another bar 8, locking member 14 is in its unlocked position.

In the situation whereby bar 8 is engaged in recess 5 and in order to lock the panel in that position, locking member 14 is rotated around bar 8 from its unlocked position into its locking position by means of said special tool.

1. A system comprising a rectangular panel being installed against the outer surface (7) of a building, wherein oblong support elements (6) are attached against said outer surface (7) and wherein said support elements (6) are provided with horizontal bars (8), wherein said panel comprises a rectangular plate like portion (1) at its front site and comprises along two opposite edges of said plate like portion (1) a backwards directed portion (2,3), wherein each backwards directed portion (2,3) is provided with a first recess (4) and a second recess (5), wherein each recess (4,5) engages one of said horizontal bars (8) and wherein at least a part of each first recess (4) extend in a direction parallel with respect to said rectangular plate like portion (1) and wherein each second recess (5) extend in a direction perpendicular with respect to said rectangular plate like portion (1), characterized in that the bars (8) engaged by said second recess (5) are provided with two locking members (14,15) being rotatable around that bar (8) between a locking position wherein the panel cannot move in the direction perpendicular with respect to the bar (8) and an unlocked position wherein the panel can move away from the bar (8).

2. A system according to claim 1, wherein said panel comprise a rectangular plate like element (1) at the frontside of the panel and each backwards directed portion is an oblong holder member (2,3) attached against the back side of said plate like element (1).

3. A system according to claim 1, wherein one of the two bars (8) engaged by said second recess (5) is provided with a fixation member (12) being fixed to that bar (8), in such way that the concerning corner of the panel cannot move in a direction parallel with the bar (8).

4. A rectangular panel to be installed against oblong support elements (6) being attached to the outer surface (7) of a building, wherein said support elements (6) are provided with horizontal bars (8), and wherein said panel comprises a rectangular plate like portion (1) at its front site and comprises along two opposite edges of said plate like portion (1) a backwards directed portion (2,3), wherein each backwards directed portion (2,3) is provided with a first recess (4) and a second recess (5), wherein each recess (4,5) can engage one of said horizontal bars (8), wherein at least a part of each first recess (4) extend in a direction parallel with respect to said rectangular plate like portion (1) and wherein each second recess (5) extend in a direction perpendicular with respect to said rectangular plate like portion (1), characterized in that the bars (8) engaged by said second recess (5) are provided with two locking members (14,15) being rotatable around that bar (8) between a locking position wherein the panel cannot move in the direction perpendicular with respect to the bar (8) and an unlocked position wherein the panel can move away from the bar (8).

5. A rectangular panel according to claim 5, wherein said plate like portion (1) is a rectangular plate like element (1) at the frontside of the panel and each backwards directed portion is an oblong holder member (2,3) attached against the back side of said plate like element (1).

6. A rectangular panel according to claim 5, wherein the panel is a solar panel provided with photovoltaic cells.

7. A method for installing a rectangular panel against the outer surface (7) of a building, whereby oblong support elements (6) being provided with bars (8) in transverse direction are attached against said outer surface (7) so that said bars (8) are horizontal directed, whereby said panel comprises a rectangular plate like portion (1) at its front site and comprises along two opposite edges of said plate like portion (1) a backwards directed portion (2,3), whereby each backwards directed portion (2,3) is provided with a first recess (4) and a second recess (5), whereby each recess (4,5) engages one of said horizontal bars (8), whereby at least a part of each first recess (4) extend in a direction parallel with respect to said rectangular plate like portion (1) and whereby each second recess (5) extend in a direction perpendicular with respect to said rectangular plate like portion (1), characterized in that a locking member (14,15) is rotated around one of the bars (8) in such way that said bar (8) cannot remove from said second recess (5).
